(19) United States
(12) Patent Application Publication
(10) Pub. No.: US 2015/0150297 A1
(43) Pub. Date: Jun. 4, 2015

(54) METHOD FOR STERILIZING SEALED AND PACKAGED FOOD USING ATMOSPHERIC-PRESSURE PLASMA, AND SEALED AND PACKAGED FOOD PREPARED THEREBY

(71) Applicants: Yun Ji Kim, Gyeonggi-do (KR); Seokin Hong, Seoul (KR); Ju Seong Kim, Gyeonggi-do (KR); Eun Jung Lee, Gyeonggi-do (KR)

(72) Inventors: Yun Ji Kim, Gyeonggi-do (KR); Seokin Hong, Seoul (KR); Ju Seong Kim, Gyeonggi-do (KR); Eun Jung Lee, Gyeonggi-do (KR)

(73) Assignee: KOREA FOOD RESEARCH INSTITUTE, Gyeonggi-do (KR)

(21) Appl. No.: 14/406,130

(22) PCT Filed: Jul. 13, 2012
(86) PCT No.: PCT/KR2012/005566

§ 371 Date: Jan. 13, 2015

(30) Foreign Application Priority Data
Jun. 7, 2012 (KR) 10-2012-0060896

(51) Int. Cl. A23L 3/3418; A23L 3/32; A23L 3/015

(52) U.S. Cl. CPC A23L 3/3418; A23L 3/015; A23L 3/32; A23V 2002/00

(57) ABSTRACT

The present disclosure relates to a method for sterilizing sealed and packaged food using atmospheric-pressure plasma and sealed and packaged food prepared thereby. The method includes: seal packaging food by injecting a gas containing 10 vol % or more of oxygen, carbon dioxide or a mixture gas thereof based on the total gas into a plastic packaging material containing the food or vacuum packing food in a plastic packaging material; and treating the packaged food with direct atmospheric-pressure plasma, thereby allowing food which cannot be heat-treated, such as fresh food, to be sterilized and allowing food to be sterilized even when polyethylene, polypropylene, nylon or polyethylene terephthalate through which plasma cannot pass is used as a food packaging material.

### TECHNICAL FIELD

The present disclosure relates to a method for sterilizing sealed and packaged food, which allows for sterilization of food packaged in a plastic packaging material using atmospheric-pressure plasma, and sealed and packaged food prepared thereby.

### BACKGROUND ART

Consumption of convenience food is increasing with the increase in leisure activities, development of food service industry and development of convenience food such as fast food accompanied by industrialization. Meanwhile, food-born diseases are increasing worldwide despite the development of sanitization techniques during food manufacturing, storage and distribution, development of hygiene-related systems, improved consumer consciousness and medical development.

In general, methods for food sterilization are classified into thermal sterilization and non-thermal sterilization. Although the thermal sterilization methods extend storage period by inhibiting the proliferation of microorganisms, they are not applicable to fresh food that cannot be heat-treated and may often have a negative effect on the inherent quality and functionality of food. In addition, the thermal sterilization methods have the problem that, even if food is sterilized such that the level of pathogenic microorganisms contained in the food is below detection limit, the level of the microorganisms may increase again during storage.

The non-thermal sterilization methods include the methods using high hydrostatic pressure, Joule heating, pulsed electric field and supercritical gas. These methods are suitable for green growth since they reduce environmental pollution and greatly improve energy efficiency and productivity.

Food irradiation is used globally for enhancing food safety. This technique is advantageous in that it is applicable to food that cannot be heat-treated and there is no risk of cross contamination because the food is sterilized after being fully packaged. However, it requires special facilities and experts for installation, maintenance and management. Above all, the technique is difficult to be commercialized because consumers are reluctant to accept it.

Atmospheric-pressure plasma is a plasma generated under atmospheric condition and is currently used in various applications including semiconductor processing, fiber processing, materials synthesis and degradation, and so forth. It is not only effective and environment-friendly without generating wastes, but also less costly in terms of application and maintenance than other sterilization methods. At present, plasma is applied in various articles for daily use without customers' reluctance. Thus, the present disclosure aims at improving sanitization of food and packaging materials through quick sterilization using atmospheric-pressure plasma.

Korean Patent Publication No. 2010-0102883 describes a method for sterilizing an object contaminated with microorganisms using atmospheric-pressure plasma. Since the method performs sterilization by directly applying plasma to an object contaminated with microorganisms, the microorganisms can be killed easily. However, contamination by microorganisms may occur again while the sterilized object is transferred into a packaging material.

Accordingly, a method which allows for sterilization of food contaminated with microorganisms, which is packaged in a packaging material, by treating with atmospheric-pressure plasma is needed.

### DISCLOSURE

### Technical Problem

The present disclosure is directed to providing a method for sterilizing sealed and packaged food which allows for sterilization of food packaged in a plastic packaging material using atmospheric-pressure plasma.

The present disclosure is also directed to providing sealed and packaged food prepared by the sterilization method.

### Technical Solution

In an aspect, the present disclosure provides a method for sterilizing sealed and packaged food, including: (a) seal packaging food by injecting a gas containing 10 vol % or more of oxygen, carbon dioxide or a mixture gas thereof based on the total gas into a plastic packaging material containing the food or vacuum packing food in a plastic packaging material by removing air; and (b) treating the packaged food with direct atmospheric-pressure plasma.

The gas in (a) may consist of oxygen, carbon dioxide or a mixture gas thereof and nitrogen.

The microorganisms that may be killed as a result of the treatment with atmospheric-pressure plasma in (b) may include Listeria, Salmonella, Escherichia coli, Staphylococcus, Bacillus and Campylobacter.

A discharge gas used to generate atmospheric-pressure plasma in (b) may be air and its flow rate may be 16000-25000 SCCM for superior sterilizing performance. The intensity of the atmospheric-pressure plasma in (b) may be 1-10 W/cm². The treatment with atmospheric-pressure plasma may be conducted for 10 seconds to 5 minutes and the rate of the treatment with atmospheric-pressure plasma may be 10-50 mm/s. These conditions are based on the assumption that the distance between the food and an atmospheric-pressure plasma electrode is 6 cm.

The plastic packaging material of the packaged food may be a film containing one or more selected from a group consisting of polyethylene, polypropylene, nylon and polyethylene terephthalate.

In another aspect, the present disclosure provides sealed and packaged food, which has been seal packaged by injecting a gas containing 10 vol % or more of oxygen, carbon dioxide or a mixture gas thereof based on the total gas or vacuum packed by removing air and then treated with direct atmospheric-pressure plasma.

The gas may be air or a mixture gas containing 60-80 vol % of nitrogen, 10-30 vol % of oxygen and 5-20 vol % of carbon dioxide.

### Advantageous Effects

A method for sterilizing sealed and packaged food of the present disclosure allows for sterilization of food which cannot be heat-treated, such as fresh food.

Also, the sterilization method of the present disclosure allows for sterilization of food even when polyethylene, polypropylene, nylon or polyethylene terephthalate through which plasma cannot pass is used as a food packaging material.

The sterilization method of the present disclosure may also be used to sterilize a processed food manufacturing facility, a food container, or the like.

### BRIEF DESCRIPTION OF DRAWINGS

FIG. 1 is a schematic cross-sectional view describing a process of treating gas-replacement packaged food with atmospheric-pressure plasma according to an exemplary embodiment of the present disclosure.

FIGS. 2-5 show the lethal dose of atmospheric-pressure plasma for different microorganisms.

FIG. 6 shows SEM images of microorganisms before and after treatment with atmospheric-pressure plasma according to an exemplary embodiment of the present disclosure.

[Detailed Description of Main Elements]

| 100: packaged food | 110: food |
|---|---|
| 120: gas | 130: packaging material |
| 200: atmospheric-pressure plasma generator | |
| 210: direct electrode | |
| 220: generated plasma | |

### BEST MODE FOR CARRYING OUT INVENTION

The present disclosure relates to a method for sterilizing sealed and packaged food, which allows for sterilization of food packaged in a plastic packaging material using atmospheric-pressure plasma, and sealed and packaged food prepared thereby.

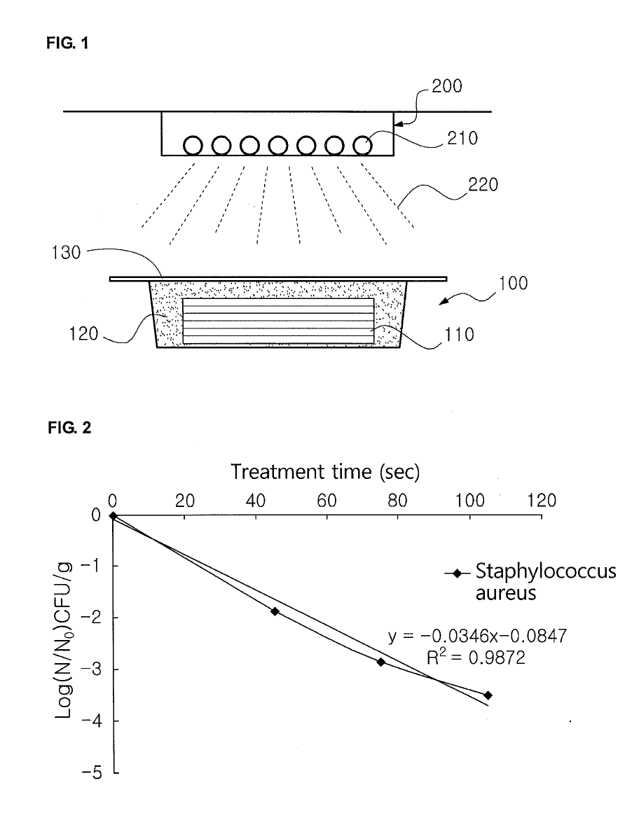

Hereinafter, the present disclosure is described in detail referring to FIG. 1.

The method for sterilizing sealed and packaged food of the present disclosure includes: (a) seal packaging food by injecting a gas containing 10 vol % or more of oxygen, carbon dioxide or a mixture gas thereof based on the total gas into a plastic packaging material containing the food or vacuum packing food in a plastic packaging material by removing air; and (b) treating the packaged food with direct atmospheric-pressure plasma.

Referring to FIG. 1, food 110 packaged in a packaging material 130 is sterilized by treating the surface of the packaged food 100 which is filled with a gas 120 or vacuum packed with atmospheric-pressure plasma 220 generated by an atmospheric-pressure plasma generator 200 equipped with a direct electrode 210.

Sealed and packaged food is sterilized as follows.

First, in (a), packaged food 100 is prepared by placing food 110 in plastic packaging material 130 and then seal packaging using a sealing machine after injecting a gas 120 or by placing food in a plastic packaging material and then seal packaging using a sealing machine.

The gas 120 filled in the packaged food 100 may be a commonly used gas which is unharmful to the human body. The gas may contain 10 vol % or more, specifically 20 vol % or more, more specifically 30-100 vol %, of oxygen, carbon dioxide or a mixture gas thereof based on the total gas.

Oxygen or carbon dioxide alone may be used as the gas. However, no sterilizing effect is achieved if nitrogen is used alone.

In an exemplary embodiment, the gas 120 may contain 60-80 vol % of nitrogen, 10-30 vol % of oxygen and 5-20 vol % of carbon dioxide. In another exemplary embodiment, the gas may contain 60-80 vol % of nitrogen and 20-40 vol % of oxygen (air). In another exemplary embodiment, the gas may contain 40-80 vol % of nitrogen and 20-60 vol % of carbon dioxide. In another exemplary embodiment, the gas may contain 100 vol % of carbon dioxide.

The vacuum packing is conducted by a commonly used method, by removing air filled between the sealing machine and the plastic packaging material.

The packaging material 130 may be a film containing one or more selected from a group consisting of polyethylene, polypropylene, nylon and polyethylene terephthalate through which plasma generated by an indirect electrode cannot pass well.

Next, in (b), the packaged food is treated with direct atmospheric-pressure plasma 220 to kill microorganisms existing in the food.

An electrode 210 used in an atmospheric-pressure plasma generator 200 generating the atmospheric-pressure plasma may be a commonly used direct electrode such as a direct dielectric barrier discharge (DBD), radio frequency discharge (RF), corona discharge (CD) electrode. Specifically, a direct DBD electrode may be used.

The intensity of the plasma generated by the atmospheric-pressure plasma generator 200 equipped with the direct electrode 210 may be 1-10 W/cm², specifically 1-5 W/cm², based on the assumption that the distance between the packaged food and the electrode is 6 cm. If the plasma intensity is lower than the lowest limit, sterilizing effect may not be achieved. And, if the plasma intensity exceeds the highest limit, it is economically inefficient and the advantage of non-thermal sterilization at low temperature is not achieved and the plastic packaging material may be deformed because of heat generation.

The treatment of the packaged food with the atmospheric-pressure plasma 220 may be conducted for 10 seconds to 5 minutes, specifically 10-70 seconds, based on the assumption that the distance between the packaged food and the electrode is 6 cm. If the plasma treatment time is shorter than the lowest limit, sterilizing effect may not be achieved. And, if the plasma treatment time exceeds the highest limit, it is economically inefficient.

The rate at which the packaged food is treated with the atmospheric-pressure plasma 220 may be 10-50 mm/s, specifically 15-20 mm/s. If the plasma treatment rate is lower than the lowest limit, a long time is required for the treatment and, as a result, the plastic packaging material may be deformed. And, if the plasma treatment rate exceeds the highest limit, sterilizing effect may not be achieved.

The plasma intensity and the plasma treatment time may be varied depending on the distance between the packaged food and the electrode 210.

A discharge gas used in the atmospheric-pressure plasma generator 200 may be specifically air and the flow rate of the discharge gas may be 16000-25000 SCCM, specifically 19000-21000 SCCM.

If the flow rate of the discharge gas is lower than the lowest limit, sterilizing effect may be decreased. And, if the flow rate exceeds the highest limit, it is economically inefficient.

Unless the packaged food is filled with the mixture gas 120, is vacuum packed or is treated with plasma generated by the direct electrode 210, the microorganisms existing in the packaged food 110 are not killed.

The microorganisms that may be killed by the sterilization method of the present disclosure may be microorganisms harmful to the human body, including Listeria, Salmonella, Escherichia coli, Staphylococcus, Bacillus, Campylobacter, etc., although not being limited thereto.

The sealed and packaged food sterilized by the above-described method may be stored for a long time.

### MODE FOR CARRYING OUT INVENTION

Hereinafter, the present disclosure will be described in detail through examples. However, the following examples are for illustrative purposes only and it will be apparent to those of ordinary skill in the art that the scope of the present disclosure is not limited by the examples.

### PREPARATION EXAMPLES 1-6

Gas-replacement packaged sliced ham was prepared by inoculating 5 log CFU/mL of Staphylococcus aureus (ATCC 12600) cultured in a nutrient medium onto sliced ham for sandwich, placing the sliced ham in a polypropylene tray container, filling air and a mixture gas, and then seal packaging with a polyethylene or nylon/polyethylene packaging film. The mixture gas MIX I consisted of 80 vol % of nitrogen and 20 vol % of oxygen; MIX II consisted of 50 vol % of nitrogen and 50 vol % of carbon dioxide; and MIX III consisted of 70 vol % of nitrogen, 20 vol % of oxygen and 10 vol % of carbon dioxide.

### PREPARATION EXAMPLES 7-8

Packaged sliced ham was prepared by inoculating 5 log CFU/mL of Staphylococcus aureus (ATCC 12600) cultured in a nutrient medium onto sliced ham for sandwich, placing the sliced ham in a polypropylene tray container, and then vacuum packing with a polyethylene or nylon/polyethylene packaging film.

### PREPARATION EXAMPLES 9-10

Gas-replacement packaged sliced ham was prepared in the same manner as in Preparation Example 1, except for using nitrogen gas.

### PREPARATION EXAMPLE 11

Gas-replacement packaged sliced ham was prepared by inoculating 5 log CFU/mL of Escherichia coli (O157:H7, ATCC 35150) cultured in a nutrient medium onto sliced ham for sandwich, placing the sliced ham in a polypropylene tray container, filling a mixture gas, and then seal packaging with a nylon/polyethylene packaging film. The mixture gas consisted of 70% of nitrogen, 20% of oxygen and 10% of carbon dioxide.

### PREPARATION EXAMPLE 12

Gas-replacement packaged sliced ham was prepared in the same manner as in Preparation Example 11, except for using Campylobacter jejuni (NCTC 11168) instead of Escherichia coli.

### PREPARATION EXAMPLE 13

Gas-replacement packaged sliced ham was prepared in the same manner as in Preparation Example 11, except for using Salmonella typhimurium (ATCC 14028) instead of Escherichia coli.

### PREPARATION EXAMPLE 14

Gas-replacement packaged jerked meat was prepared by inoculating 5 log CFU/mL of Staphylococcus aureus (ATCC 12600) cultured in a nutrient medium onto jerked meat, placing the jerked meat in a polypropylene tray container, filling a mixture gas, and then seal packaging with a nylon/polyethylene packaging film. The mixture gas consisted of 70% of nitrogen, 20% of oxygen and 10% of carbon dioxide.

### EXAMPLES 1-3, 5-7, 9-11 AND 13-15

The gas-replacement packaged sliced hams prepared in Preparation Examples 1-6 were sterilized using an atmospheric-pressure plasma generator equipped with a direct DBD electrode. As a discharge gas, argon gas was fed at a flow rate of 20000 SCCM. The intensity of the generated plasma was 30 and 50 W and the plasma treatment rate was 15 mm/s. The distance between the electrode and the packaged sliced ham was 6 cm.

### EXAMPLES 4, 8, 12 AND 16

The vacuum packed sliced hams prepared in Preparation Examples 7 and 8 were sterilized in the same manner as in Examples 1, 5, 9 and 13.

### COMPARATIVE EXAMPLES 1-4

The nitrogen-replacement packaged sliced hams prepared in Preparation Examples 9 and 10 were sterilized in the same manner as in Examples 1, 5, 9 and 13.

### COMPARATIVE EXAMPLES 5-44

Packaged sliced hams were sterilized in the same manner as in Examples 1-16. An indirect RF or indirect DBD electrode was used and the intensity of generated plasma was 100 or 200 W.

### TEST EXAMPLE 1

### Living Cell Counting

25 g of the sliced hams sterilized in the examples and comparative examples and 225 mL of sterile saline were placed in a stomacher bag, agitated and then serially diluted 10-fold. 0.1 mL of the diluate was taken and the number of living cells was counted using Baird-Parker agar according to the standard plate count technique (KFDA). After seeding onto the plate and culturing at 37° C. for 24 hours, the number of colonies (colony-forming unit; CFU) was counted.

TABLE 1

| | | Intensity | | | Treatment(SEC) | | | | |
|---|---|---|---|---|---|---|---|---|---|
| | Plasma | (W) | Packaging | Gas | 0 | 5 | 10 | 30 | 60 |
| Example 1 | Direct | 30 | PE | N₂ | 4.6 ± 0.3 | 4.0 ± 0.6 | 3.6 ± 0.4 | 3.2 ± 0.2 | 3.2 ± 0.3 |
| Example 2 | DBD | | | MIX I | 4.6 ± 0.2 | 3.3 ± 0.5 | 2.9 ± 0.3 | 2.2 ± 0.5 | 1.8 ± 0.4 |
| Example 3 | | | | MIX II | 4.6 ± 0.3 | 2.9 ± 0.2 | 2.4 ± 0.4 | 2.0 ± 0.5 | 1.3 ± 0.3 |
| Example 4 | | | | MIX III | 4.6 ± 0.2 | 3.0 ± 0.4 | 2.5 ± 0.2 | 2.0 ± 0.3 | 1.5 ± 0.1 |
| Example 5 | | | NYPE | N₂ | 4.6 ± 0.3 | 4.1 ± 0.2 | 3.7 ± 0.3 | 3.2 ± 0.2 | 3.2 ± 0.3 |
| Example 6 | | | | MIX I | 4.7 ± 0.1 | 3.2 ± 0.4 | 3.0 ± 0.2 | 2.5 ± 0.3 | 2.0 ± 0.3 |
| Example 7 | | | | MIX II | 4.5 ± 0.2 | 3.0 ± 0.3 | 2.7 ± 0.1 | 2.3 ± 0.2 | 1.6 ± 0.2 |
| Example 8 | | | | MIX III | 4.5 ± 0.3 | 3.1 ± 0.4 | 2.7 ± 0.4 | 2.4 ± 0.4 | 1.8 ± 0.2 |
| Example 9 | | 50 | PE | N₂ | 4.6 ± 0.3 | 3.9 ± 0.1 | 3.5 ± 0.5 | 3.2 ± 0.2 | 2.9 ± 0.5 |
| Example 10 | | | | MIX I | 4.5 ± 0.2 | 2.5 ± 0.5 | 1.8 ± 0.4 | 1.3 ± 0.4 | 0.4 ± 0.2 |
| Example 11 | | | | MIX II | 4.5 ± 0.2 | 2.1 ± 0.1 | 1.3 ± 0.2 | 0.5 ± 0.2 | ND** |
| Example 12 | | | | MIX III | 4.6 ± 0.1 | 2.4 ± 0.4 | 1.6 ± 0.1 | 1.0 ± 0.4 | ND** |
| Example 13 | | | NYPE | N₂ | 4.5 ± 0.4 | 3.9 ± 0.1 | 3.6 ± 0.3 | 2.9 ± 0.5 | 2.8 ± 0.4 |
| Example 14 | | | | MIX I | 4.6 ± 0.1 | 2.7 ± 0.4 | 2.0 ± 0.3 | 1.5 ± 0.1 | 0.8 ± 0.3 |
| Example 15 | | | | MIX II | 4.6 ± 0.1 | 2.2 ± 0.2 | 1.3 ± 0.3 | 0.6 ± 0.2 | ND** |
| Example 16 | | | | MIX III | 4.6 ± 0.2 | 2.7 ± 0.4 | 1.9 ± 0.5 | 1.2 ± 0.3 | 0.3 ± 0.5 |
| Comparative | Indirect | 100 | PE | N₂ | 4.6 ± 0.2 | 4.4 ± 0.5 | 4.5 ± 0.3 | 4.3 ± 0.2 | 4.2 ± 0.2 |
| Example 1 | DBD | | | | | | | | |
| Comparative | | | | MIX I | 4.7 ± 0.1 | 4.5 ± 0.2 | 4.4 ± 0.3 | 4.3 ± 0.5 | 4.3 ± 0.3 |
| Example 2 | | | | | | | | | |
| Comparative | | | | MIX II | 4.5 ± 0.3 | 4.4 ± 0.3 | 4.4 ± 0.2 | 4.3 ± 0.3 | 4.3 ± 0.1 |
| Example 3 | | | | | | | | | |
| Comparative | | | | MIX III | 4.5 ± 0.2 | 4.4 ± 0.2 | 4.4 ± 0.4 | 4.3 ± 0.3 | 4.3 ± 0.3 |
| Example 4 | | | | | | | | | |
| Comparative | | | NYPE | N₂ | 4.6 ± 0.3 | 4.6 ± 0.5 | 4.3 ± 0.4 | 4.4 ± 0.1 | 4.3 ± 0.2 |
| Example 5 | | | | | | | | | |
| Comparative | | | | MIX I | 4.5 ± 0.3 | 4.2 ± 0.3 | 4.4 ± 0.2 | 4.5 ± 0.3 | 4.4 ± 0.1 |
| Example 6 | | | | | | | | | |
| Comparative | | | | MIX II | 4.5 ± 0.2 | 4.3 ± 0.4 | 4.3 ± 0.2 | 4.3 ± 0.5 | 4.3 ± 0.4 |
| Example 7 | | | | | | | | | |
| Comparative | | | | MIX III | 4.6 ± 0.2 | 4.2 ± 0.4 | 4.5 ± 0.1 | 4.3 ± 0.4 | 4.3 ± 0.1 |
| Example 8 | | | | | | | | | |
| Comparative | | 200 | PE | N₂ | 4.6 ± 0.3 | 4.3 ± 0.5 | 4.4 ± 0.2 | 4.2 ± 0.4 | 4.4 ± 0.2 |
| Example 9 | | | | | | | | | |
| Comparative | | | | MIX I | 4.5 ± 0.2 | 4.4 ± 0.3 | 4.4 ± 0.5 | 4.3 ± 0.2 | 4.5 ± 0.1 |
| Example 10 | | | | | | | | | |
| Comparative | | | | MIX II | 4.5 ± 0.3 | 4.5 ± 0.4 | 4.5 ± 0.2 | 4.4 ± 0.3 | 4.4 ± 0.1 |
| Example 11 | | | | | | | | | |
| Comparative | | | | MIX III | 4.5 ± 0.1 | 4.6 ± 0.1 | 4.5 ± 0.3 | 4.4 ± 0.2 | 4.3 ± 0.3 |
| Example 12 | | | | | | | | | |
| Comparative | | | NYPE | N₂ | 4.6 ± 0.1 | 4.2 ± 0.7 | 4.2 ± 0.5 | 4.3 ± 0.3 | 4.4 ± 0.1 |
| Example 13 | | | | | | | | | |
| Comparative | | | | MIX I | 4.4 ± 0.3 | 4.5 ± 0.2 | 4.3 ± 0.3 | 4.2 ± 0.3 | 4.3 ± 0.5 |
| Example 14 | | | | | | | | | |
| Comparative | | | | MIX II | 4.4 ± 0.5 | 4.4 ± 0.2 | 4.3 ± 0.2 | 4.3 ± 0.1 | 4.3 ± 0.5 |
| Example 15 | | | | | | | | | |
| Comparative | | | | MIX III | 4.5 ± 0.2 | 4.4 ± 0.2 | 4.3 ± 0.5 | 4.3 ± 0.1 | 4.4 ± 0.2 |
| Example 16 | | | | | | | | | |
| Comparative | Indirect | 100 | PE | N₂ | 4.5 ± 0.1 | 4.6 ± 0.4 | 4.3 ± 0.3 | 4.4 ± 0.1 | 4.5 ± 0.3 |
| Example 17 | RF | | | | | | | | |
| Comparative | | | | MIX I | 4.6 ± 0.3 | 4.4 ± 0.2 | 4.4 ± 0.1 | 4.3 ± 0 .3 | 4.2 ± 0.3 |
| Example 18 | | | | | | | | | |
| Comparative | | | | MIX II | 4.5 ± 0.4 | 4.4 ± 0.2 | 4.4 ± 0.3 | 4.3 ± 0.3 | 4.3 ± 0.2 |
| Example 19 | | | | | | | | | |
| Comparative | | | | MIX III | 4.4 ± 0.3 | 4.3 ± 0.3 | 4.2 ± 0.2 | 4.3 ± 0.4 | 4.3 ± 0.3 |
| Example 20 | | | | | | | | | |
| Comparative | | | NYPE | N₂ | 4.6 ± 0.3 | 4.4 ± 0.2 | 4.4 ± 0.1 | 4.3 ± 0.3 | 4.2 ± 0.3 |
| Example 21 | | | | | | | | | |
| Comparative | | | | MIX I | 4.6 ± 0.2 | 4.5 ± 0.1 | 4.4 ± 0.5 | 4.5 ± 0.3 | 4.4 ± 0.2 |
| Example 22 | | | | | | | | | |
| Comparative | | | | MIX II | 4.5 ± 0.5 | 4.4 ± 0.5 | 4.4 ± 0.3 | 4.3 ± 0.2 | 4.3 ± 0.1 |
| Example 23 | | | | | | | | | |
| Comparative | | | | MIX III | 4.5 ± 0.3 | 4.5 ± 0.3 | 4.5 ± 0.2 | 4.3 ± 0.3 | 4.3 ± 0.3 |
| Example 24 | | | | | | | | | |
| Comparative | | 200 | PE | N₂ | 4.6 ± 0.2 | 4.4 ± 0.5 | 4.2 ± 0.3 | 4.4 ± 0.4 | 4.5 ± 0.2 |
| Example 25 | | | | | | | | | |
| Comparative | | | | MIX I | 4.6 ± 0.4 | 4.5 ± 0.5 | 4.5 ± 0.2 | 4.4 ± 0.3 | 4.4 ± 0.2 |
| Example 26 | | | | | | | | | |
| Comparative | | | | MIX II | 4.5 ± 0.5 | 4.5 ± 0.2 | 4.5 ± 0.4 | 4.4 ± 0.4 | 4.4 ± 0.5 |
| Example 27 | | | | | | | | | |
| Comparative | | | | MIX III | 4.5 ± 0.3 | 4.5 ± 0.3 | 4.5 ± 0.2 | 4.3 ± 0.3 | 4.3 ± 0.3 |
| Example 28 | | | | | | | | | |
| Comparative | | | NYPE | N₂ | 4.5 ± 0.4 | 4.3 ± 0.5 | 4.0 ± 0.3 | 4.2 ± 0.3 | 4.3 ± 0.1 |
| Example 29 | | | | | | | | | |
| Comparative | | | | MIX I | 4.6 ± 0.1 | 4.6 ± 0.5 | 4.3 ± 0.5 | 4.5 ± 0.2 | 4.3 ± 0.3 |
| Example 30 | | | | | | | | | |
| Comparative | | | | MIX II | 4.5 ± 0.3 | 4.5 ± 0.3 | 4.4 ± 0.2 | 4.4 ± 0.1 | 4.3 ± 0.3 |
| Example 31 | | | | | | | | | |
| Comparative | | | | MIX III | 4.6 ± 0.2 | 4.4 ± 0.2 | 4.4 ± 0.3 | 4.4 ± 0.2 | 4.3 ± 0.2 |
| Example 32 | | | | | | | | | |

*ND: Not detected

As seen from Table 1, the sterilization according to Examples 1-16 showed superior sterilizing power to Comparative Examples 1-4. In particular, superior sterilizing power could be achieved even with lower plasma intensity than those of Comparative Examples 5-44. The number of living microorganisms decreased gradually with plasma treatment time.

Sterilizing power was better when the packaged food was filled with the mixture gas (MIX II, III), as compared to when nitrogen or air (MIX I) was filled. Although sterilizing effect could be achieved with vacuum packing, the effect was lower than when air was filled.

It is thought that superior sterilizing effect is achieved when the packaged food is filled with oxygen or carbon dioxide rather than an inert gas such as nitrogen, because induced charge is formed upon plasma treatment.

In contrast, Comparative Examples 5-44 showed little decrease in microorganisms with plasma treatment time.

The same result was observed for Listeria monocytogenes (ATCC 19115), Salmonella typhimurium (ATCC 14028), Escherichia coli (O157:H7, ATCC 35150), Bacillus cereus (ATCC 14579), Campylobacter jejuni (ATCC 49943) and Campylobacter jejuni (NCTC 11168).

### EXAMPLE 17

The gas-replacement packaged sliced ham prepared in Preparation Example 11 was contaminated with microorganisms and sterilized in the same manner as in Example 15.

### EXAMPLE 18

The gas-replacement packaged sliced ham prepared in Preparation Example 12 was contaminated with microorganisms and sterilized in the same manner as in Example 15.

### EXAMPLE 19

The gas-replacement packaged sliced ham prepared in Preparation Example 13 was contaminated with microorganisms and sterilized in the same manner as in Example 15.

### TEST EXAMPLE 2

### Measurement of Lethal Dose (D-Value)

Log N/No CFU/g was measured at different times to determine the lethal dose of the packaged sliced hams prepared in Examples 15 and 17-19.

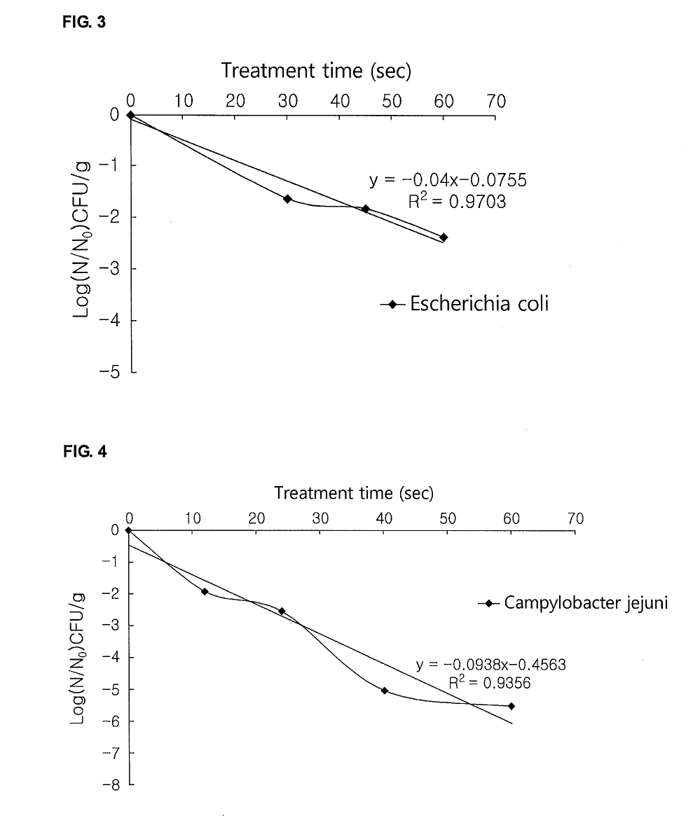

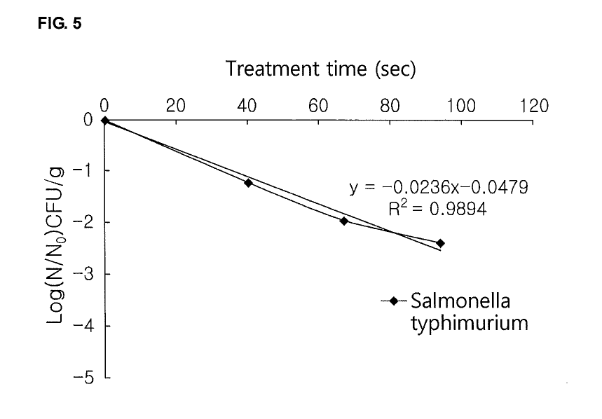

As a result, the lethal dose was found to be 0.48 min for Staphylococcus aureus (FIG. 2), 0.41 min for Escherichia coli (FIG. 3), 0.17 min for Campylobacter jejuni (FIGS. 4) and 0.70 min for Salmonella typhimurium (FIG. 5).

### TEST EXAMPLE 3

### SEM Imaging

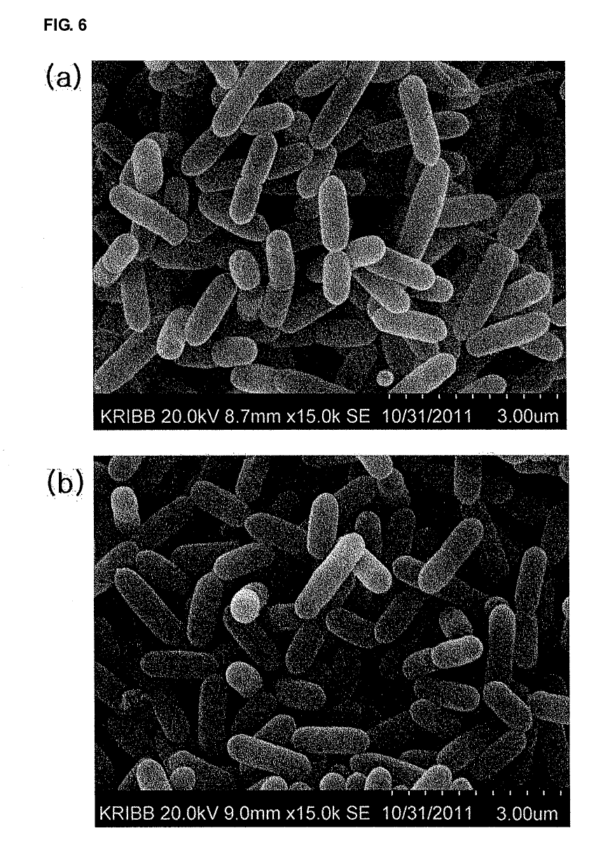

FIG. 6 shows scanning electron microscopic (SEM) images of the packaged sliced ham prepared in Preparation Example 12 before plasma treatment (FIG. 6a) and the packaged sliced ham prepared in Preparation Example 18 after plasma treatment for 60 seconds (FIG. 6b).

As seen from FIG. 6a, the Campylobacter jejuni inoculated onto the sliced ham showed a typical spiral shape before the plasma treatment. In contrast, as seen from FIG. 6b, the Campylobacter jejuni inoculated onto the sliced ham showed a circular shape after the plasma treatment. This shape change was consistent with the result of absorbance measurement. Specifically, the OD value measured at 600 nm was 0.13 before the plasma treatment and 0.07 after the plasma treatment.

This result shows that the plasma treatment resulted in stresses.

### EXAMPLE 20

The gas-replacement packaged jerked meat prepared in Preparation Example 14 was treated with plasma in the same manner as in Example 15.

### TEST EXAMPLE 4

### Color Measurement of Jerked Meat

The color of the packaged jerked meat prepared in Preparation Example 14 (before plasma treatment) and the packaged jerked meat prepared of Example 20 (after plasma treatment for 60 seconds) was measured. As a result, the brightness of the packaged jerked meat was 25.91 and 25.67, respectively, before and after the plasma treatment. The redness was 4.33 and 4.46 and the yellowness was −3.68 and −3.33, respectively. To conclude, there was little change in color after the treatment with atmospheric-pressure plasma.

### INDUSTRIAL APPLICABILITY

Since a method for sterilizing sealed and packaged food of the present disclosure allows for sterilization of food which cannot be heat-treated, such as fresh food, a variety of fresh food can be provided.

1. A method for sterilizing sealed and packaged food, comprising:
(a) seal packaging food by injecting a gas comprising 10 vol % or more of oxygen, carbon dioxide or a mixture gas thereof based on the total gas into a plastic packaging material containing the food or vacuum packing food in a plastic packaging material by removing air; and
(b) treating the packaged food with direct atmospheric-pressure plasma.

2. The method for sterilizing sealed and packaged food according to claim 1, wherein the gas in (a) is air.

3. The method for sterilizing sealed and packaged food according to claim 1, wherein the gas in (a) comprises 60-80 vol % of nitrogen, 10-30 vol % of oxygen and 5-20 vol % of carbon dioxide.

4. The method for sterilizing sealed and packaged food according to claim 1, wherein, as a result of the treatment with atmospheric-pressure plasma in (b), the microorganisms Listeria, Salmonella, Escherichia coli, Staphylococcus, Bacillus and Campylobacter are killed.

5. The method for sterilizing sealed and packaged food according to claim 1, wherein the intensity of the atmospheric-pressure plasma in (b) is 1-10 W/cm².

6. The method for sterilizing sealed and packaged food according to claim 1, wherein the treatment with atmospheric-pressure plasma in (b) is conducted for 10 seconds to 5 minutes.

7. The method for sterilizing sealed and packaged food according to claim 1, wherein the rate of the treatment with atmospheric-pressure plasma in (b) is 10-50 mm/s.

8. The method for sterilizing sealed and packaged food according to claim 5, wherein the distance between the food and an atmospheric-pressure plasma electrode is 6 cm.

9. The method for sterilizing sealed and packaged food according to claim 1, wherein a discharge gas used to generate atmospheric-pressure plasma in (b) is air.

10. The method for sterilizing sealed and packaged food according to claim 9, wherein the flow rate of the discharge gas is 16000-25000 SCCM.

11. The method for sterilizing sealed and packaged food according to claim 1, wherein the plastic packaging material of the packaged food is a film comprising one or more selected from a group consisting of polyethylene, polypropylene, nylon and polyethylene terephthalate.

12. Sealed and packaged food, which has been seal packaged by injecting a gas comprising 10 vol % or more of oxygen, carbon dioxide or a mixture gas thereof based on the total gas or vacuum packed by removing air and then treated with direct atmospheric-pressure plasma.

13. The sealed and packaged food according to claim 12, wherein the gas is air.

14. The sealed and packaged food according to claim 12, wherein the gas comprises 60-80 vol % of nitrogen, 10-30 vol % of oxygen and 5-20 vol % of carbon dioxide.
